(19) United States
(12) Patent Application Publication
(10) Pub. No.: US 2023/0059605 A1
(43) Pub. Date: Feb. 23, 2023

(54) RESOLUTION OF CUSTOMER ISSUES

(71) Applicant: Hewlett-Packard Development Company, L.P., Spring, TX (US)

(72) Inventors: Shameed Sait M A, Bangalore (IN); Shreyans Dhankhar, Bangalore (IN); Yeswanth Siva Tej Gowd Kuruba, Bangalore (IN); Niranjan Damera Venkata, Chennai (IN)

(73) Assignee: Hewlett-Packard Development Company, L.P., Spring, TX (US)

(21) Appl. No.: 17/793,966

(22) PCT Filed: Feb. 7, 2020
(86) PCT No.: PCT/US2020/017244

§ 371 Date: Jul. 20, 2022

(51) Int. Cl. G06Q 30/00

(52) U.S. Cl. CPC G06Q 30/016

(57) ABSTRACT

Aspects of resolution of customer issues are discussed. A customer issue may be presented to a human agent as a query. The human agent may provide an agent response for the query. Based on the agent response, a simulated customer message may be determined. Iteratively, agent responses may be received and simulated customer messages may be provided to resolve the query. A sequence of agent responses and simulated customer messages usable to resolve the query may be probabilistically determined based on the agent responses and the simulated customer messages.

### BACKGROUND

Companies utilize customer support centers to provide assistance to customers for resolving customer issues. At these centers, customer care agents answer telephone calls or chat requests from customers for resolving issues.

### BRIEF DESCRIPTION OF DRAWINGS

The following detailed description references the figures, wherein:

FIG. 1 illustrates a system for determining responses for resolving customer issues, according to an example implementation of the present subject matter.

FIG. 2 illustrates a system for training a machine learning model for resolution of customer issues, according to an example implementation of the present subject matter.

FIG. 3 illustrates a computing environment for providing resolution of customer issues, according to an example implementation of the present subject matter.

FIGS. 4a and 4b illustrate example user interfaces for determining responses for resolution of customer issues, according to an example implementation of the present subject matter.

FIG. 5 illustrates a method of determining responses for providing resolution of customer issues, according to an example implementation of the present subject matter.

FIG. 6 illustrates a method of simulating customer messages in a simulated conversation, according to an example implementation of the present subject matter; and

FIG. 7 illustrates a computing environment, implementing a non-transitory computer-readable medium for determining responses for providing resolution of customer issues, according to an example implementation of the present subject matter.

### DETAILED DESCRIPTION

Customers may contact customer support centers for receiving support related to various enquiries, resolving problems, and the like. At the customer support centers, people, referred to as human agents, may respond to customer queries. The efficiency with which the customer queries are resolved is related to the cost of providing the support services and customer satisfaction.

While some human agents, such as expert agents, may be able to quickly and efficiently resolve customer issues, other human agents may not be able to provide guidance as efficiently as expert agents, thereby resulting in low customer satisfaction, increased time for issue resolution, and higher overall costs of customer support. Sometimes, agent assistance applications, such as applications trained based on historical call data, may be made available to human agents to help them provide better customer support. The agent assistance applications may provide suggested responses to the human agents to help them respond to customer issues.

Historical call data used to train the agent assistance applications may include details of calls (including voice calls and text messages) that were handled by human agents in the past. The details may include, for example, queries posed by customers, customer background information, resolution steps provided, customer messages received, whether the call succeeded, suggestions for more efficient resolution, and the like. The details of calls may be obtained from transcripts of the calls and notes provided by the human agents.

In some scenarios, computer implemented applications, referred to as virtual agents, may converse with the customers instead of human agents and may provide automated guidance to customers to help with the resolution of customer issues. The virtual agents may also be trained based on the historical call data.

For ease of discussion, agent assistance applications and virtual agents may be referred to as support applications. As the support applications may learn from large volumes of historical call data, they may be expected to resolve issues more efficiently than some human agents, for example, inexperienced human agents.

However, in some scenarios, the support applications may not be able to resolve customer issues efficiently. For example, in cases where the training data does not include issues similar to an issue received by a support application, the support application may be unable to resolve the issue efficiently. In another example, if the training data includes a larger amount of data related to calls handled by non-expert agents than by expert agents, the support applications may be inefficient in resolving customer issues. However, it may not be feasible to selectively use historical call data related to calls handled by expert agents for training the support applications because such call volumes may be low compared to the total call volume and such data may not be sufficient for training the support applications.

Aspects of the present subject matter relate to simulating a conversation with a customer, also referred to as a user, and providing a user interface through which expert agents may participate in the simulated conversation. The resolution steps provided by the expert agents during the simulated conversation may be used to train support applications for efficient issue resolution. Various aspects of the present subject matter also relate to providing efficient resolution of customer issues by the support applications, including virtual agents and agent assistance applications, that were trained using the knowledge of expert agents, thereby increasing the efficiency of the support applications and also helping other human agents who use agent assistance applications to benefit from the knowledge of the expert agents.

In an example, a problem or customer issue may be identified from a real case and the case details may be presented to a human agent, such as an expert agent, as a query on a user interface. A real case may refer to a call that may have been handled by a human agent in the past. In one example, the case details may be obtained from historical call data. The user interface may list a set of resolution steps, also referred to as troubleshooting steps, for the issue identified from the real case. The troubleshooting steps may be determined from the historical call data, for example, using a first machine learning model. The troubleshooting steps determined from the historical call data may be presented contextually on the user interface to the human agent as suggested responses.

The human agent may select a response from the suggested responses as their response, also referred to as agent response, or may provide a different troubleshooting step as the agent response. Based on the agent response, a customer message, also referred to as simulated customer message, may be determined and may be provided on the user interface in response to the agent response. In an example, the customer message may be determined using a second machine learning model that may also have been trained based on the historical call data.

In an example, the agent responses are iteratively received, and the customer messages are iteratively provided to resolve the customer query, thus simulating a conversation of a customer with the human agent. A sequence of agent responses and customer messages used to resolve the query may be probabilistically determined from the received agent responses and customer messages and used to train a third machine learning model. In an example, the third machine learning model may be trained based on learning of Markov transitions or Deep Learning from the agent responses and the customer messages. The third machine learning model may be subsequently implemented by a support application for facilitating resolution of customer issues.

In an example, as multiple expert agents may provide agent responses for similar problems, a wide coverage of resolution routes used by the expert agents may be obtained for training the third machine learning model. Further, an agent assistance application may be trained based on the third machine learning model, which may be used by a human agent, for example, an inexperienced human agent, for providing troubleshooting steps as efficiently as provided by expert agents for a real-time query received from a live customer. Thus, the present subject matter helps inexperienced human agents benefit from the knowledge of the expert agents, thereby increasing their productivity and reducing call times and costs. Additionally, the third machine learning model may also be used by a virtual agent to provide support to customers, reducing the number of calls to be handled by human agents and increasing the efficiency of the customer support process.

The present subject matter may thus learn from a variety of resolution routes used by the expert agents for different types of issues, which may not be otherwise available in historical call data. Thus, the present subject matter can help codify the knowledge of expert agents for efficient resolution of customer issues. In one example, the user interface used may be a gamification interface. In the gamification interface, various game-like elements may be provided, such as score keeping, competition between different expert agents, recording time to resolution, and the like, to increase the engagement of expert agents and collect more and better quality data for training the third machine learning model.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

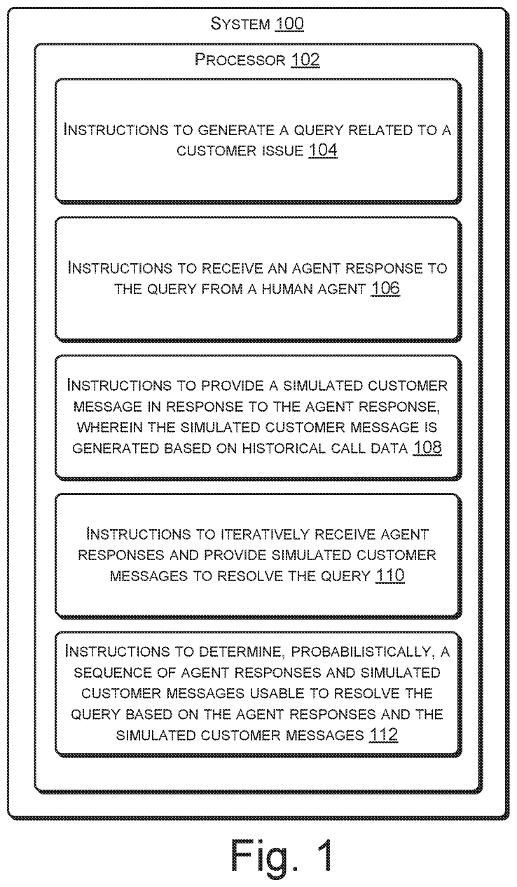

FIG. 1 illustrates a system 100 for determining responses for resolving customer issues, according to an example implementation of the present subject matter. The system 100 may be implemented as any of a variety of systems, such as a desktop computer, a laptop computer, a server, a tablet device, and the like.

The system 100 includes a processor 102. The processor 102 may be implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions. The functions of the processor 102 may be provided through the use of dedicated hardware as well as hardware capable of executing machine readable instructions.

In addition to the processor 102, the system 100 may also include interface(s) and system data (not shown in FIG. 1). The interface(s) may include a variety of machine readable instructions-based interfaces and hardware interfaces that allow interaction with a customer and with other communication and computing devices, such as network entities, web servers, networked computing devices, external repositories, and peripheral devices. The system data may serve as a repository for storing data that may be fetched, processed, received, or created by the processor 102.

In operation, the processor 102 may execute instructions 104 to generate a query related to a customer issue. The query may be an expression of an issue faced by a customer who is a user of the products or services provided by an organization. In an example, a query may be related to an issue being faced by the user while operating a product. For example, a query “unable to print using a wireless printer” or “wireless printer not connected to network” may be related to issues faced by a customer while operating a wireless printer.

In one example, the processor 102 may generate a query for a customer issue identified from historical call data. In another example, the processor 102 may select the query from a database that stores queries received from human agents for training of the human agents. In another example, the processor 102 may select the query from queries identified by human agents as those where more efficient resolution steps or troubleshooting steps are to be determined than those being provided by agent assistance applications or virtual agents.

The query may be presented to a human agent on a user interface. In one example, the user interface may be provided on a display of the system 100. In another example, the user interface may be provided on another computing device, which may be in communication with the system 100.

Further, the processor 102 may execute instructions 106 to receive an agent response to the query from a human agent, for example, an expert agent. An expert human agent may be a person who is able to efficiently resolve the customer issue through a series of troubleshooting steps. In one example, based on the query, a set of suggested troubleshooting steps may be provided by the processor 102 on the user interface to help the human agent provide a response. In one example, the suggested troubleshooting steps may be identified by a first machine learning model based on historical call data. The human agent may select a step from the list of troubleshooting steps as the agent response or may provide a different troubleshooting step as the agent response.

Based on the agent response, the processor 102 may execute instructions 108 to provide a simulated customer message in response to the agent response. The simulated customer message may also be generated based on the historical call data. In an example, the simulated customer message may be determined using a second machine learning model and may be presented on the user interface.

Further, the processor 102 may execute instructions 110 to iteratively receive agent responses from the human agent and provide simulated customer messages on the user interface to resolve the query.

The processor 102 may further execute instructions 112 to probabilistically determine a sequence of agent responses and simulated customer messages usable to resolve the query based on the agent responses and the simulated customer messages. In one example, the agent responses and the simulated customer messages may be stored in a database along with other agent responses and simulated customer messages obtained from similar exercises carried out by other expert human agents and may be used to train a third machine learning model to resolve the customer query. As a part of the training of the third machine learning model, the probability of providing a particular agent response in response to a particular simulated customer message may be determined and may be used subsequently by virtual agents and agent assistance applications to suggest an agent response while executing the third machine learning model. In an example, the third machine learning model may be trained based on learning of Markov transitions or Deep Learning from the agent responses and the simulated customer messages. In an example, the system 100 that trains the third machine learning model may be the same as or different from the one that executes the third machine learning model.

As multiple expert agents may provide agent responses for similar problems, a wide coverage of resolution routes used by expert agents may be obtained for training the third machine learning model. A support application may be trained based on the third machine learning model for providing troubleshooting steps as efficiently as provided by the expert agent for a real-time query received from a live customer. Thus, the present subject matter helps in the resolution of customer issues by allowing inexperienced human agents and virtual agents to benefit from the knowledge of the expert agents.

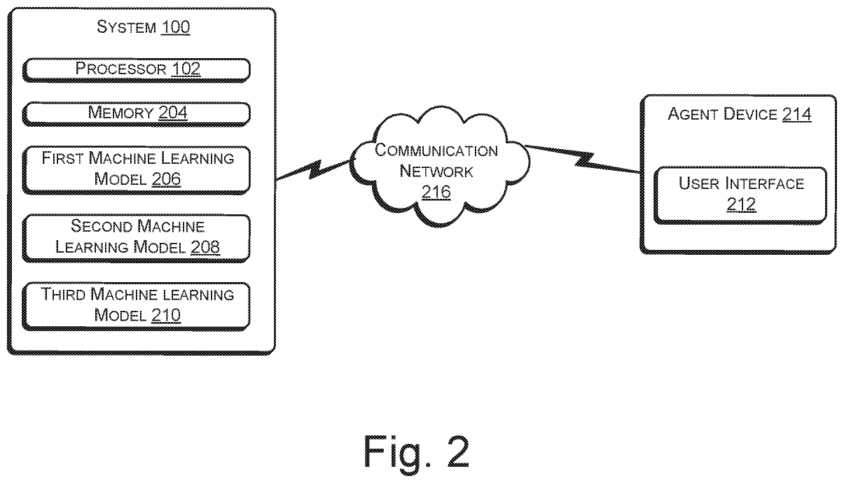

FIG. 2 illustrates a system for training a machine learning model for resolution of customer issues, according to an example implementation of the present subject matter.

The system 100 may include a memory 204 coupled to the processor 102. In an example, a first machine learning model 206, a second machine learning model 208, a third machine learning model 210, and other data, such as historical call data, agent responses, and customer messages, and the liked may be stored in the memory 204 of the system 100. The memory 204 may include any non-transitory computer-readable medium including volatile memory (e.g., RAM), and/or non-volatile memory (e.g., EPROM, flash memory, Memristor, etc.). The memory 204 may also be an external memory unit, such as a flash drive, a compact disk drive, an external hard disk drive, a database, or the like.

A customer issue may be identified from a real case and the case details may be presented on a user interface 212 of a computing device used by a human agent, referred to as an agent device 214. The user interface 212 and information presented thereon may be generated by the system 100 and displayed on a display of the agent device 214. The human agents may also provide responses through the user interface 212. In one example, the agent device 214 may be a mobile phone, a desktop computer, a laptop computer, a notebook, or the like.

In an example, the system 100 may be connected to the agent device 214 through a communication network 216, for example, in a cloud environment. In another example, the system 100 and the agent device 214 may be the same device, i.e., the user interface 212 may be presented on a display of the system 100 and the human agent may use the system 100 to provide their responses.

On the user interface 212, the case details may be provided as a query with background context in a manner similar to what would be available to the human agent when responding to a customer call in real-time. In one example, the user interface 212 may be a gamification interface that includes various game-like elements, such as score keeping, competition between different expert agents, and recording time to resolution, to increase the engagement of expert agents and collect more data for training the third machine learning model 210.

The user interface 212 may also list a set of troubleshooting steps, identified for the query, by execution of the first machine learning model 206. In an example, the first machine learning model 206 may have been trained by the system 100 or a different system based on historical call data.

The human agent may select a step from the set of troubleshooting steps as their response, also referred to as agent response, or may provide their own troubleshooting step as the agent response on the user interface 212. Based on the agent response, a simulated customer message may be determined by execution of the second machine learning model 208 and provided on the user interface 212. In an example, the second machine learning model 208 may also have been trained based on the historical call data by the system 100 or a different system.

In one example, a knowledge base of troubleshooting steps may be used in addition to the historical call data to determine the simulated customer message. The knowledge base may include predefined agent responses that are standardized and are distinct from each other. Initially, each troubleshooting step of the historical call data may be mapped to a predefined agent response of the knowledge base. For example, a troubleshooting step such as “please reboot the printer” may be mapped to the predefined agent response “restart the printer” in the knowledge base. In an example, the mapping may be done based on sentence similarity using cosine similarity of sentence embeddings.

Further, customer messages in the historical call data that were received in response to the troubleshooting steps mapped to a predefined agent response are also mapped to that predefined agent response. The customer messages which are mapped to the same predefined agent response may be grouped together. For example, customer messages such as ‘done’, ‘customer restarted the printer’, ‘printer is not rebooting’, and the like are mapped to the predefined agent response ‘restart the printer’. These customer messages may be grouped together for clustering.

In an example, the clustering may be performed using K-means clustering and a number of clusters (K) to be used may be identified, for example, using an elbow technique. In one example, the identified number of clusters may be increased by a predefined percentage to obtain greater variation in customer messages. In one example, the identified number of clusters may be increased by 25% to derive customer message clusters. For example, if the identified number of clusters is 8, then 25% more clusters or 10 clusters may be formed using the K-means clustering technique.

After the customer message clusters are derived, a centroid of each cluster may be used as a representative customer message of the cluster. In an example, the centroids are validated and cleaned by human agents, such as expert agents. In one example, each representative customer message may be ranked by providing a score using a conditional probability. The conditional probability may be given by:

$${R}_{score} = P ( \frac{Acti o n}{R} ) * P ( R )$$

where
R_{score} is the ranking score given to a customer message R;
P(Action/R) is the conditional probability of the troubleshooting step ‘Action’ being provided to the user given the customer message R; and
P(R) is the probability of the customer message R being provided.

Using the conditional probability, low scores are provided to commonly occurring customer messages and high scores are provided to the customer messages specific to the agent response. For example, the specific response “IP address not found” may have a higher score than the common response “done” for the agent response “Ping IP address of the printer”.

In other examples, other ranking techniques may be used to rank the representative customer messages. From the ranked customer representative messages, the message with the highest rank may be provided by the system 100 to the user interface 212 as the simulated customer message in response to the agent response. Further, the human agent may provide another agent response in response to the simulated customer message provided by the system 100. Thus, a customer-agent conversation may be simulated where agent responses and customer messages may be iteratively provided for resolving the query.

The system 100 may record the sequence of agent responses and simulated customer messages used to resolve the query. Similarly, the sequence of agent responses and simulated customer messages used to resolve the query in other simulated customer-agent conversations conducted with other expert agents may be recorded. The system 100 may then probabilistically determine a sequence of agent responses and simulated customer messages usable to resolve the query based on the recorded sequences of agent responses and simulated customer messages.

In one example, the third machine learning model 210 may be trained using the recorded sequences of agent responses and simulated customer messages to probabilistically determine the sequence of agent responses and simulated customer messages usable to resolve the query. In an example, the third machine learning model 210 may be trained based on learning of Markov transitions or Deep Learning from the recorded agent responses and simulated customer messages.

In an example, the trained third machine learning model 210 may be subsequently implemented in an agent assistance application to assist a human agent, for example, an inexperienced human agent, in providing troubleshooting steps to a real-time customer query as efficiently as provided by expert agents. In another example, the trained third machine learning model 210 may be subsequently implemented in a virtual agent application for providing the troubleshooting steps to a customer in a real case.

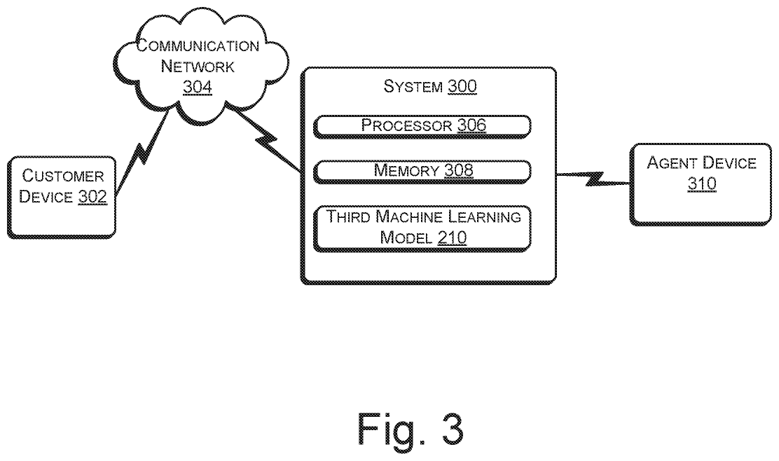

FIG. 3 illustrates a computing environment for providing resolution of customer issues, according to an example implementation of the present subject matter. In the computing environment, a system 300 may be connected to customer device 302 through a communication network 304. In one example, the computing environment may be a cloud environment. For example, the system 300 may be implemented in the cloud to provide various services to the customer device 302.

The system 300 includes a processor 306. The processor 306 may fetch and execute computer-readable instructions. The functions of the processor 306 may be provided through the use of dedicated hardware as well as hardware capable of executing machine readable instructions. The system 300 may also include a memory 308 coupled to the processor 306. In an example, the third machine learning model 210 may be stored in the memory 308 of the system 300.

The system 300 may be a desktop computer, a server, a laptop, a personal computer, or the like. The customer device 302 may be, for example, a laptop, a personal computer, a tablet, a multi-function printer, a smart device, a mobile phone, a landline phone, and the like.

The communication network 304 may be a wireless or a wired network, or a combination thereof. The communication network 304 may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network includes various network entities, such as transceivers, gateways, and routers.

In operation, a human agent, using an agent device 310, may receive a query from a customer sent through the customer device 302. The agent device 310 may be, for example, a laptop, a mobile device, a tablet, a desktop computer, or the like. In an example, the agent device 310 may communicate with the system 300 over a network (not shown in the figure). The query received from the customer may be related to a customer issue, such as issues about products/services of interest, working of the product, and the like.

In an example, the system 300 that may execute the third machine learning model 210 may be the same as or different from the system 100 on which the third machine learning model was trained. The third machine learning model 210 may have been trained based on the agent responses and simulated customer messages that had been used to resolve customer queries in simulated conversations between a human agent and the system 100 as discussed above.

In an example, the system 300 may implement an agent assistance application that may execute the third machine learning model 210. In another example, the agent assistance application that may execute the third machine learning model 210 may be implemented on the agent device 310. The agent assistance application may provide suggested troubleshooting steps to the agent device 310 for use by the human agent. The human agent may select a troubleshooting step from the suggested troubleshooting steps to respond to the customer query or may also provide their own troubleshooting step. Since the agent assistance application is based on the third machine learning model 210, the troubleshooting steps provided by the human agent may be as efficient as those provided by an expert. Thus, the present subject matter helps inexperienced human agents benefit from the knowledge of the expert agents.

In other examples, the third machine learning model 210 may also be used by a virtual agent (not shown in the figure) to efficiently provide support to customers, thereby reducing the number of calls to be handled by human agents and reducing customer support costs.

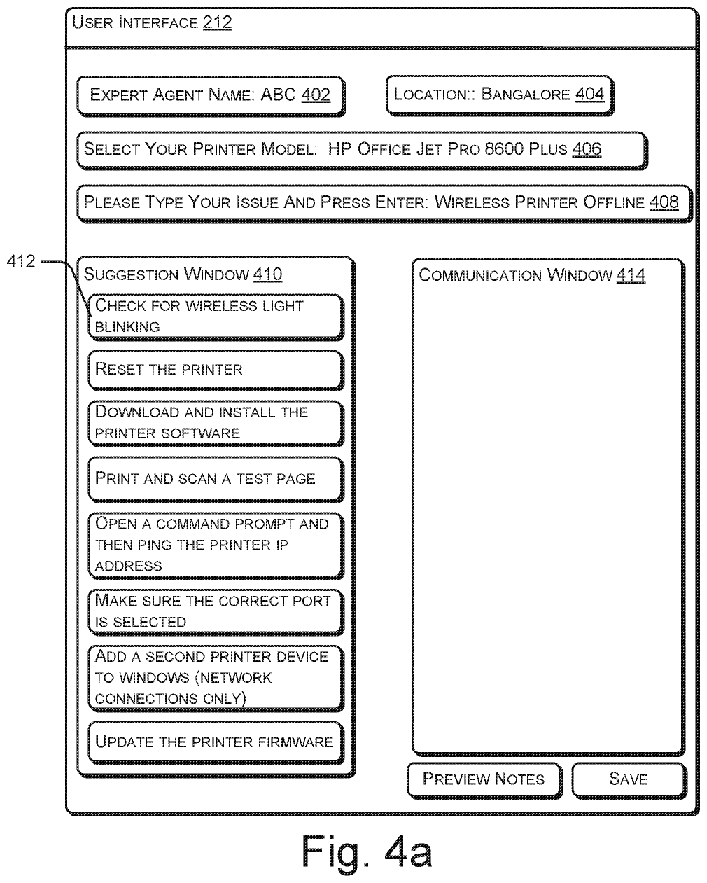

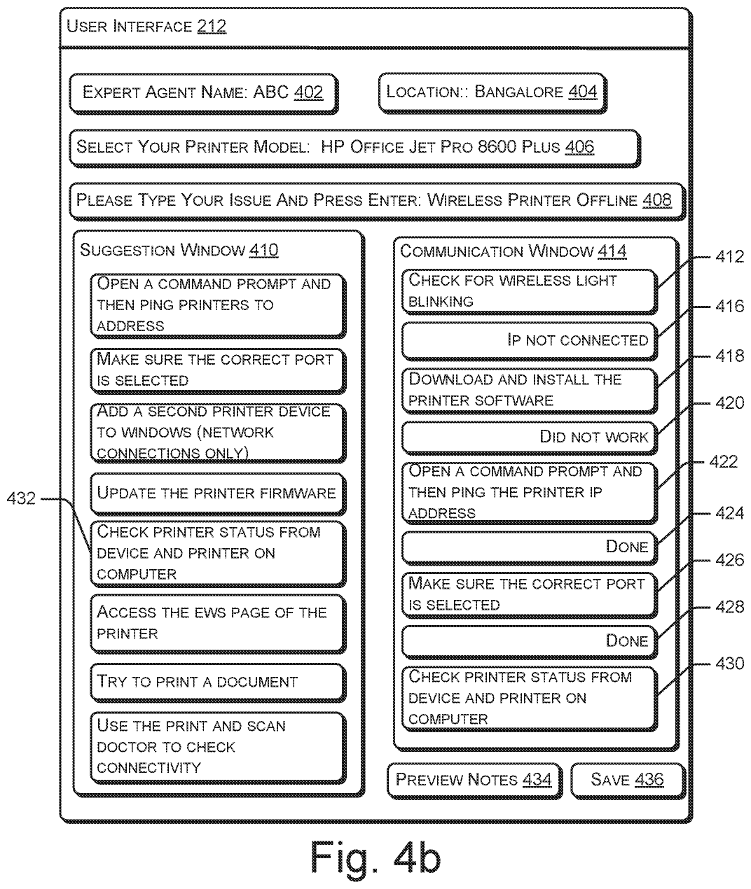

FIGS. 4a and 4b illustrate example user interfaces 212 for determining responses for resolution of customer issues, according to an example implementation of the present subject matter. The example user interface 212, as shown in FIG. 4a may be provided on the agent device 214 by the system 100 to allow a human agent, such as an expert agent, to participate in a simulated conversation with a customer to determine a sequence of agent responses and simulated customer messages usable to resolve a customer issue. The user interface 212 may be such that it appears to the expert agent that they are in conversation with a customer.

The user interface 212 can include blocks 402 and 404 for receiving information about the expert agent who is participating in the simulated conversation. For example, the name and location of the agent may be received in blocks 402 and 404, respectively. In an example, background information of a product for which resolution is sought may be provided on the user interface 212. In an example, a model of the printer for which an issue is to be resolved may be mentioned in block 406. For example, a printer model number for example, HP® Office Jet Pro 8600 Plus, may be provided at block 406. Based on the issue to be resolved, the system 100 may provide information about the issue and a customer query on the user interface 212. In an example, as shown in FIG. 4a, the issue may be related to the working of a printer and a query related to the issue being faced with the printer model may be mentioned on a query window 408 by the system 100. In one example, the system 100 may generate the query related to a customer issue from historical call data and may present the query on the user interface 212.

On providing the query, the system 100 may also provide a set of troubleshooting steps related to the query in a suggestion window 410. The troubleshooting steps may be determined from historical call data based on the query provided in the query window 408 and the background information provided in block 406 as discussed earlier. In an example, the first machine learning model 206 may be executed by the system 100 to determine the set of troubleshooting steps to be displayed in the suggestion window 410. In one example, the troubleshooting steps may be presented contextually. For example, the troubleshooting steps may be ordered based on their complexity or frequency of usage or similarity to the issue.

In an example, the expert agent may choose one troubleshooting step, such as the troubleshooting step at block 412, as their response. In another example, the expert agent may input a different troubleshooting step as their response. The user interface 212 may further include a communication window 414 to display the troubleshooting steps provided by the expert agent, also referred to as agent responses, and customer messages simulated in response to the agent responses.

As shown in FIG. 4b, the communication window 414 displays the conversation between the expert agent and the system 100 acting as the customer. For example, if the expert agent selects ‘check for wireless light blinking’ from the suggestion window 410, it may be displayed in the communication window 414 as block 412. A simulated customer message for example, ‘IP not connected’ may be provided by the block 416. As discussed earlier, the simulated customer message may be determined based on the historical call data, for example, using the second machine learning model 208. Further, the expert agent may provide the next agent response for example, ‘download and install the printer software’ at block 418. In response to the agent response, the next simulated customer message, for example, ‘did not work’ may be provided at block 420 by the system 100. The expert agent may further provide the next agent response for example, ‘open a command prompt and then ping the printer IP address’ at block 422. In response to block 422, the simulated customer message for example, ‘done’ may be provided at block 424.

Similarly, the expert agent may provide a next agent response ‘make sure the correct port is selected’ as shown in block 426 and may receive a corresponding simulated customer message ‘done’ as shown in block 428.

In one example, after each simulated customer message is received in the communication window 414, the suggested troubleshooting steps in the suggestion window 410 may be updated by the system 100 based on the last customer message received and in the context of the query and previous troubleshooting steps provided in the communication window 414. For example, the suggested troubleshooting steps shown in suggestion window 410 of FIG. 4b may be provided after the simulated customer message ‘done’ is received at block 428 from the system 100 indicating that it has been ensured that the correct port has been selected. In one example, the expert agent may provide an agent response as shown in block 430 asking the customer to check the printer status by selecting block 432 from the suggestion window 410.

Thus, the process may continue until the query or customer issue is resolved, as may be indicated in a customer message. In an example, once the query is resolved, the expert agent may select the block 434 to add their observations as case notes. In an example, the expert agent may then select the block 436 to store the sequence of agent responses and customer messages used for resolving the query and the case notes. Thus, sequences of agent responses and customer messages usable to resolve the query may be learned from multiple expert agents and used to subsequently train support applications as discussed earlier.

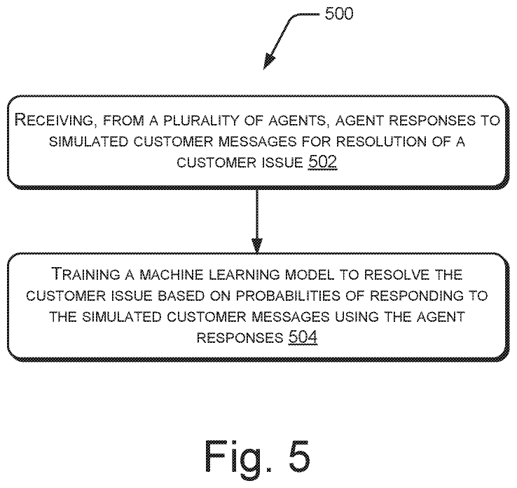

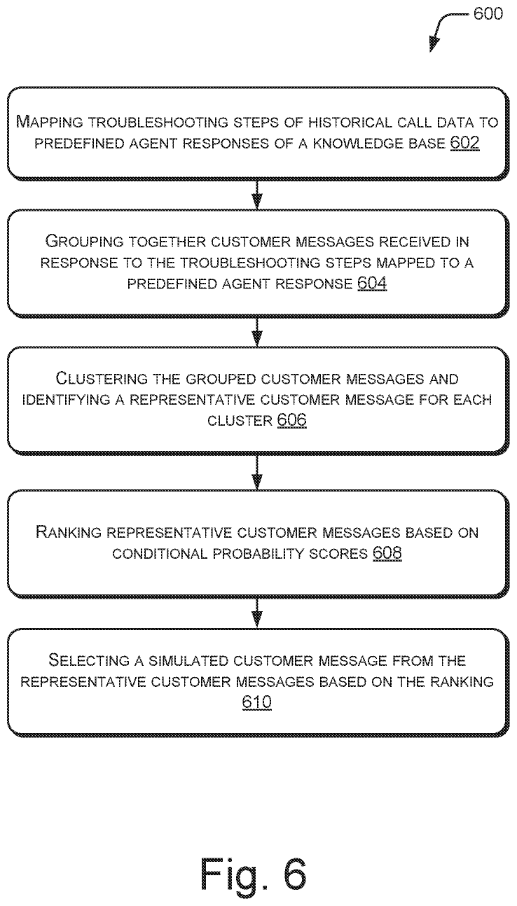

FIG. 5 illustrates a method of determining responses for providing resolution of customer issues, according to an example implementation of the present subject matter. FIG. 6 illustrates a method of simulating customer messages in a simulated conversation, according to an example implementation of the present subject matter. The order in which the methods 500 and 600 are described is not intended to be construed as a limitation, and some of the described method blocks can be combined in a different order to implement the methods or alternative methods. Furthermore, the methods 500 and 600 may be implemented in any suitable hardware, computer-readable instructions, or combination thereof. The blocks of the methods 500 and 600 may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer-readable and encode computer-executable instructions, where the instructions perform some or all of the blocks of the methods 500 and 600. While the methods 500 and 600 may be implemented in any device, the following description is provided in the context of systems 100 and 300 as described earlier with reference to FIGS. 1-3 for ease of discussion.

Referring to method 500, at block 502, agent responses to simulated customer messages may be received from a plurality of agents for resolution of a customer issue. In an example, the agents may provide the agent responses through user interfaces 212 provided on their respective agent device. In an example, a query related to the customer issue may be generated and presented on a user interface 212. Based on the query, the user interface 212 may provide a set of suggested troubleshooting steps identified by a first machine learning model based on historical call data. In an example, human agents such as expert agents may select a step from the list of troubleshooting steps as the agent response or may provide a different troubleshooting step as the agent response.

Based on the agent response, a simulated customer message may be determined and may be provided on the user interface 212. The simulated customer message may be generated based on the historical call data. In an example, the simulated customer message may be determined using a second machine learning model.

The user interface 212 may iteratively receive agent responses from the human agent and provide simulated customer messages to resolve the query. Further, a sequence of agent responses and simulated customer messages usable to resolve the query based on the agent responses and the simulated customer messages are probabilistically determined. In one example, the sequence of agent responses and the simulated customer messages may be stored in a database along with other sequence of agent responses and simulated customer messages obtained from other expert human agents.

At block 504, a machine learning model, such as the third machine learning model 210, may be trained to resolve the customer issue based on probabilities of responding to the simulated customer messages using the agent responses. The third machine learning model 210 may have been trained based on the sequence of agent responses and the simulated customer messages stored in the database.

In an example, an agent assistance application may execute the third machine learning model 210, which may be used by a human agent, for example, an inexperienced human agent, for providing troubleshooting steps for a real-time query received from a live customer. Thus, the present subject matter helps inexperienced human agents benefit from the knowledge of the expert agents.

FIG. 6 illustrates a method 600 of simulating customer messages in a simulated conversation, according to an example implementation of the present subject matter. In an example, to determine a simulated customer message in response to an agent response, a second machine learning model may be executed. The second machine learning model 208 may have been trained based on historical call data. In an example, the second machine learning model is the second machine learning model 208.

In some examples, a knowledge base of troubleshooting steps may also be used in addition to the historical call data to determine the simulated customer message. In an example, the knowledge base may include predefined agent responses that are standardized and are distinct from each other.

At block 602, each troubleshooting step in the historical call data may be mapped to a predefined agent response of the knowledge base. In an example, the mapping may be done based on sentence similarity using cosine similarity of sentence embeddings. The customer messages in the historical call data that are received in response to the troubleshooting steps mapped to the predefined agent response are also mapped to that predefined agent response.

At block 604, the customer messages used to respond to the troubleshooting steps mapped to the same predefined agent responses of the knowledge base may be grouped together.

At block 606, the grouped customer messages are clustered to identify representative customer messages. In an example, the clustering may be performed using K-means clustering and a number of clusters (K) to be used may be identified, for example, using an elbow technique. In one example, the identified number of clusters may be increased by a predefined percentage to obtain greater variation in customer messages. After the customer message clusters are derived, a centroid of each cluster may be used as a representative customer message of the cluster. In an example, the centroids are validated and cleaned by human agents, such as expert agents.

At block 608, each representative customer message may be ranked by providing a score using a conditional probability. The conditional probability may be given by:

$${R}_{score} = P ( \frac{Acti o n}{R} ) * P ( R )$$

Using the conditional probability, in an example, low scores may be provided to commonly occurring representative customer messages and high scores may be provided to the representative customer messages specific to the agent response. For example, the specific response “IP address not found” may have a higher score than the common response “done” for the agent response “Ping IP address of the printer”.

At block 610, a representative customer message may be selected as the simulated customer message based on the ranking. In an example, the representative customer message with a high score may be selected as the simulated customer message for being provided on the user interface 212 in response to an agent response.

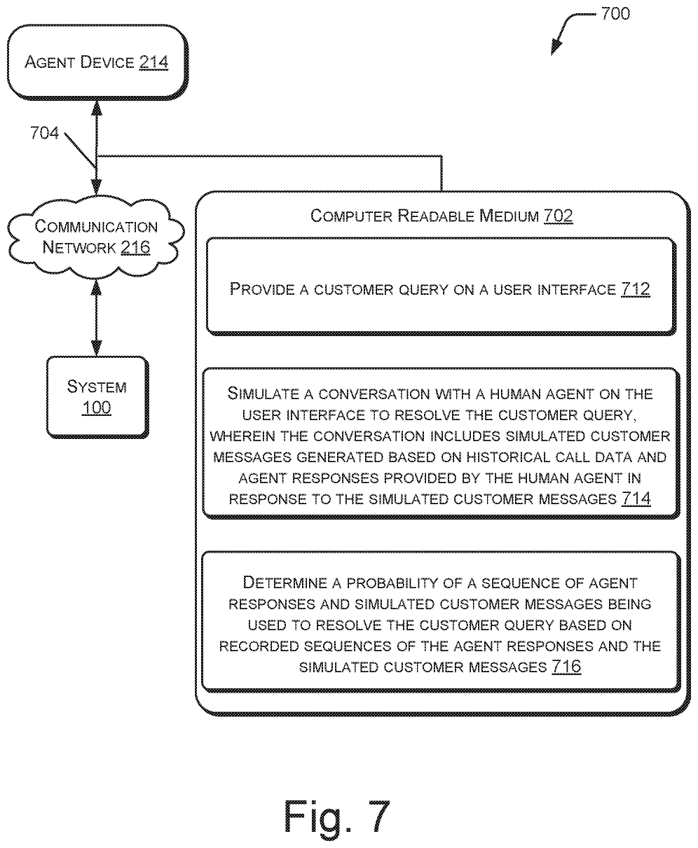

FIG. 7 illustrates a computing environment 700, implementing a non-transitory computer-readable medium for determining responses for providing resolution of customer issues, according to an example implementation of the present subject matter.

In an example, the non-transitory computer-readable medium 702 may be utilized by a system, such as the system 100. The computing environment 700 includes an agent device, such as the agent device 214, and the system 100 communicatively coupled to the non-transitory computer-readable medium 702 through a communication link 704. The non-transitory computer-readable medium 702 may be, for example, an internal memory device or an external memory device. In some examples, the non-transitory computer-readable medium 702 may be a part of the memory 204.

In an example implementation, the computer-readable medium 702 includes a set of computer-readable instructions, which can be accessed by the processor 102 of the system 100 and subsequently executed to provide resolution of customer issues.

In one implementation, the communication link 704 may be a direct communication link, such as any memory read/write interface. In another implementation, the communication link 704 may be an indirect communication link, such as a network interface. In such a case, the system 100 may access the non-transitory computer-readable medium 702 through a communication network 216. The communication network 216 may be a single network or a combination of multiple networks and may use a variety of different communication protocols.

Referring to FIG. 7, in an example, the non-transitory computer-readable medium 702 includes instructions 712 that cause the processor 102 of the system 100 to provide a customer query on a user interface 212 of the agent device 214. The user interface 212 may be provided by the processor 102 as a gamification interface comprising game-like elements. In response to the query, a set of troubleshooting steps may be listed on the user interface 212 as suggestions for an agent. In an example, the set of troubleshooting steps may be determined by execution of a first machine learning model 206 that may have been trained based on historical call data.

The non-transitory computer-readable medium 702 includes instructions 714 that cause the processor 102 of the system 100 to simulate a conversation with the human agent, for example, an expert agent using the agent device 214, to resolve the customer query. In an example, the conversation may include simulated customer messages generated based on historical call data and agent responses provided by the human agent in response to the simulated customer message as described earlier.

In an example, the simulated customer message may be determined by execution of a second machine learning model 208. For example, the simulated customer messages may be generated based on clustering and ranking of simulated customer messages received in response to similar agent responses as determined from the historical call data. In one example, a knowledge base of troubleshooting steps may be used in addition to the historical call data to determine the simulated customer message.

In an example, the agent responses and the simulated customer messages usable to resolve the query may be recorded. Similarly, the sequence of agent responses and simulated customer messages used to resolve the query in other simulated customer agent conversations conducted with other expert agents may also be recorded.

At block 716, the system 100 may determine a probability of a sequence of agent responses and simulated customer messages being used to resolve the customer query based on recorded sequences of the agent responses and the simulated customer messages. In one example, a third machine learning model 210 may be trained using the recorded sequences of agent responses and simulated customer messages to probabilistically determine the sequence of agent responses and simulated customer messages usable to resolve the query.

In an example, the third machine learning model 210 may be subsequently implemented in an agent assistance application to assist a human agent, for example, an inexperienced human agent, in providing troubleshooting steps to a real-time customer query as efficiently as provided by expert agents. Thus, the present subject matter helps inexperienced human agents benefit from the knowledge of the expert agents. Additionally, the third machine learning model may also be used in a virtual agent application for providing the troubleshooting steps to a customer in a real case.

The present subject matter thus helps in codifying expert agent knowledge for increasing the productivity of human agents, reducing average call handle time of human agents, reducing call volumes received by human agents by more efficient issue resolution using virtual agents, and saving overall customer support costs.

The preceding description has been presented to illustrate and describe examples of the principles described. This description is not intended to be exhaustive. Many modifications and variations are possible in light of the above teaching.

1. A system comprising
a processor to:
generate a query related to a customer issue;
receive an agent response in response to the query from a human agent;
provide a simulated customer message in response to the agent response, wherein the simulated customer message is generated based on historical call data;
iteratively receive agent responses and provide simulated customer messages to resolve the query; and
determine, probabilistically, a sequence of agent responses and simulated customer messages usable to resolve the query based on the agent responses and the simulated customer messages.

2. The system of claim 1, wherein the processor is to provide a set of troubleshooting steps determined based on the historical call data as suggested agent responses and to receive a selected troubleshooting step from the set of troubleshooting steps as the agent response.

3. The system of claim 1, wherein the processor is to generate the simulated customer message based on clustering of customer messages received in response to similar agent responses in the historical call data and selecting the simulated customer message based on a ranking of the customer messages.

4. The system of claim 1, wherein, to determine, probabilistically, the sequence of agent responses and simulated customer messages usable to resolve the query, the processor is to train a machine learning model based on the agent responses and the simulated customer messages.

5. The system of claim 1, wherein the processor is to generate a user interface comprising:
a query window to display the query;
a suggestion window to display a set of suggested troubleshooting steps determined based on historical call data; and
a communication window to display the iteratively received agent responses and the customer messages provided for resolving the query.

6. The system of claim 5, wherein the user interface is a gamification interface comprising game-like elements.

7. A method comprising:
receiving, from a plurality of agents, agent responses to simulated customer messages for resolution of a customer issue; and
training a machine learning model to resolve the customer issue based on probabilities of responding to the simulated customer messages using the agent responses.

8. The method of claim 7 comprising simulating a customer message in response to an agent response received from an agent of the plurality of agents based on historical call data and providing the simulated customer message on to the agent.

9. The method of claim 8, wherein the simulating comprises:
mapping troubleshooting steps of the historical call data to predefined agent responses of a knowledge base;
grouping together customer messages received in response to the troubleshooting steps mapped to a predefined agent response;
clustering the grouped customer messages and identifying a representative customer message for each cluster;
ranking representative customer messages based on conditional probability scores; and
selecting a simulated customer message from the representative customer messages based on the ranking.

10. The method of claim 9, wherein the clustering of the grouped customer messages is based on K-means clustering and the representative customer message of a cluster is a centroid of the cluster.

11. The method of claim 7, wherein the training of the machine learning model is based on learning of Markov transitions or Deep Learning from the agent responses and the simulated customer messages.

12. The method of claim 7 comprising executing the machine learning model to resolve real-time customer issues.

13. A non-transitory computer-readable medium comprising instructions for resolution of customer issues, the instructions being executable by a processor to:
provide a customer query on a user interface;
simulate a conversation with a human agent on the user interface to resolve the customer query, wherein the conversation includes simulated customer messages generated based on historical call data and agent responses provided by the human agent in response to the simulated customer messages; and
determine a probability of a sequence of agent responses and simulated customer messages being used to resolve the customer query based on recorded sequences of the agent responses and the simulated customer messages.

14. The non-transitory computer-readable medium of claim 13, wherein the instructions are executable by the processor to provide the user interface as a gamification interface comprising game-like elements.

15. The non-transitory computer-readable medium of claim 13, wherein the instructions are executable by the processor to generate the simulated customer messages based on clustering and ranking of customer messages received in response to similar agent responses as determined from the historical call data.
